(19) United States
(12) Patent Application Publication
(10) Pub. No.: US 2022/0263255 A1
(43) Pub. Date: Aug. 18, 2022

(54) WIRE CONNECTOR

(71) Applicant: ORIENS KOREA CO., LTD., Incheon (KR)

(72) Inventors: Sang Pil LEE, Incheon (KR); Jae Won PARK, Incheon (KR)

(73) Assignee: ORIENS KOREA CO., LTD., Incheon (KR)

(21) Appl. No.: 17/618,749

(22) PCT Filed: Jul. 30, 2019
(86) PCT No.: PCT/KR2019/009479

§ 371 Date: Dec. 13, 2021

(30) Foreign Application Priority Data
Jun. 14, 2019 (KR) 10-2019-0070898

(51) Int. Cl. H01R 4/22; H01R 4/12; H01R 4/72

(52) U.S. Cl. CPC H01R 4/22; H01R 4/72; H01R 4/12

(57) ABSTRACT

Disclosed is a wire connector. This device comprises: a wire connection part having a cap shape of which the outer circumferential surface is serrated, and connecting, by means of rotation, stripped portions of a plurality of wires to be connected which are inserted therein in a twisted shape by using a metal insert equipped therein; and a bond-type heat shrinkage tube which is hollow and cylindrical, has one side integrally attached to the outer circumferential surface of the bottom of the wire connection part, and has the other end through which the plurality of wires to be connected are inserted such that the bond-type heat shrinkage tube shrinks when heated.

### TECHNICAL FIELD

The present invention relates to a wire connector, and in particular, a wire connector capable of finishing wire connection of a stripped portion of an electric wire inserted therein through rotation of a wire connection unit having an outer peripheral surface in a serrated shape, and capable of completely sealing a non-stripped portion of the wire to a lower part of the wire connection unit without a gap by a bond type heat-shrinkable tube having a high shrinkage rate.

### BACKGROUND ART

In general, as a method of connecting cut wires in an electronic product or during electrical construction, a part of the sheath formed of synthetic resin, etc. surrounding the outside of the cut wires is firstly peeled off, followed by twisting the stripped portion of the wires to be connected and connecting the same, otherwise, a separate connection member is used for wire connection.

Since the stripped portion of the wire to be connected as described above is an electrical conductor through which current flows, there is a problem of occurrence of an accident such as electric shock and short circuit.

To solve this problem, an insulation tape is typically used to wrap and insulate the stripped portion.

However, when covering the stripped portion in the same way as above, there is a hassle of wrapping the insulation tape on the stripped portions of the wires separately. Further, there is a limitation that, if the insulation tape is aged due to long use, the tape may be partially peeled off to cause the wire to be corroded or vulnerable to waterproofing.

In order to overcome such limitations, a connection method using a wire connector has recently been used.

The wire connector generally includes a rectangular tapered coil metal insert made of a metal material into which a stripped portion of the wire may be inserted, and a housing formed of a synthetic resin as an insulating material to surround the metal insert.

Further, if the stripped portion of the wire to be connected is inserted into the wire connector and rotated, the stripped portion of the wire is twisted and connected by the metal insert.

However, using such a wire connector as described above has a problem in that a plurality of connected wires may be easily separated due to weak binding force, or electrical problems such as short circuit, poor contact, electric leakage, etc. may occur due to inflow of foreign substances (moisture, dust, etc.) into an opening (of the wire connector).

In particular, there is an increased risk that the connected portion of the wire may become loose due to external environments such as a change in temperature, vibration, etc., hence coming off from the wire connector.

Meanwhile, a heat-shrinkable tube recently used for insulation of the connected wire has a thin thickness to thus cause difficulties in implying sufficient insulation layers. Further, it is difficult to prevent damage due to external force or friction and/or to protect a wire connection unit from moisture and humidity.

In addition, it is difficult to use a torch during shrinking work since a heat-shrinkable tube has a low flame-retardant level, thus causing a limitation of requiring a hot air fan.

Accordingly, the present inventors have provided a bond type heat-shrinkable tube that can reliably finish wire connection at a stripped portion of the wire inserted into a wire connector while sealing the other portion of the wire (not stripped) to an outer peripheral surface of the wire connector, leading to a conception of a wire connector capable of insulating and sealing the connected wires while preventing omission or corrosion of the wire, moisture penetration, or the like.

### Disclosure

### Technical Problem

It is an object of the present invention to provide a wire connector that reliably finishes wire connection of a stripped portion of a wire inserted into the wire connector through rotation of a wire connection unit having an outer peripheral surface in a serrated shape, and can seal the other portion of the wire not stripped (“non-stripped portion”) to a lower part of the wire connection unit by a bond type heat-shrinkable tube having a high shrinkage rate.

The problem to be solved by the present invention is not limited to the problem(s) mentioned above, and other problem(s) that are not mentioned herein will be clearly understood by those skilled in the art from the following description.

### Technical Solution

In order to achieve the above object, the present invention may provide a wire connector, including: a wire connection unit in a cap shape having an outer peripheral surface in a serrated shape to connect stripped portions of a plurality of wires to be connected, which was inserted into the wire connector, in a twisted form through rotation thereof by means of a built-in metal insert thereof; and a bond type heat-shrinkable tube in a hollow and cylindrical shape that has one side integrally attached to a lower outer peripheral surface of the wire connection unit and the other side, through which the plurality of wires to be connected is inserted, thereby being shrunk when heated.

The wire connection unit of the wire connector according to the present invention to achieve the above object may include: a housing in a tapered cylindrical shape having a larger radius of an open lower portion than a closed upper side, wherein the plurality of wires to be connected is inserted on the lower portion; and the metal insert disposed inside the housing, which is formed in a hollow and tapered cylindrical shape having a screw-shaped outer surface, and into which the stripped portion is inserted and connected.

The housing of the wire connector according to the present invention to achieve the above object is characterized by being formed of an insulating material such as a plastic or ceramic material.

The housing of the wire connector according to the present invention to achieve the above object is characterized in that it rotates in a predetermined direction while the stripped portion is inserted into the wire connection unit so as to connect the stripped portion in a twisted shape.

The metal insert of the wire connector according to the present invention to achieve the above object may be formed in a tapered coil shape and twist the stripped portion through rotation of the wire connection unit, thereby connecting the wire inside the wire connector.

The metal insert of the wire connector according to the present invention to achieve the above object is characterized by being formed of an electrically conductive material including steel and copper.

The bond type heat-shrinkable tube of the wire connector according to the present invention to achieve the above object is characterized in that a portion connected to the lower part of the wire connection unit among the non-stripped portion of the wire to be connected may be shrunk when heated using a predetermined heat source, and the tube may seal the non-stripped portion to the lower part of the wire connection unit.

The predetermined heat source of the wire connector according to the present invention to achieve the above object may be any one among a torch, a hot air fan and a portable turbo-lighter.

The bond type heat-shrinkable tube of the wire connector according to the present invention to achieve the above object may have a shrinkage rate in the range of 3:1 to 6:1.

The bond type heat-shrinkable tube of the wire connector according to the present invention to achieve the above object is characterized in that an outer surface thereof may be made of any one of polyolefin (PO), polyvinylidene fluoride (PVDF) and soft polyvinyl (PVC), which is being cross-linkable by radiation.

The bond type heat-shrinkable tube of the wire connector according to the present invention to achieve the above object is characterized in that an inner surface thereof may be made of any one of an ethylene-vinyl acetate copolymer (EVA)-based adhesive and a polyamide (PA)-based adhesive.

Details of other embodiments will be included in the “detailed description of preferred embodiments for carrying out the invention” and the accompanying “drawings”.

Advantages and/or features of the present invention, and a method for achieving the same will become apparent with reference to various embodiments described below as well as the accompanying drawings.

However, the present invention is not limited only to the configuration of each embodiment disclosed below, but may be implemented in various different forms, and only each embodiment disclosed in the present specification makes the disclosure of the present invention complete. Further, it should be understood that the present invention is provided to completely inform the scope of the present invention to those skilled in the art, and the present invention is only defined by the scope of each of the appended claims

### Advantageous Effects

According to the present invention, it is possible to prevent a hassle caused by the conventional covering method using an insulation tape, and an electrical problem due to inflow of foreign substances and corrosion of the wire due to ageing of the insulation tape.

Even if a connected part of the wire is aged or a lower diameter of the wire connection unit is larger than a diameter of the inserted wires, it is possible to prevent a phenomenon that the connected part of the wire is falling out due to vibration or shaking caused by weather or movement since the bond type heat-shrinkable tube has a high shrinkage rate.

### DESCRIPTION OF DRAWINGS

FIG. 1 is an external perspective view of a wire connector according to an embodiment of the present invention.

FIG. 2 is a front view of the wire connector shown in FIG. 1.

FIG. 3 is an enlarged cross-sectional view or a wire connection unit 100 in the wire connector shown in FIG. 2.

FIG. 4 is a partially cut-away view of the wire connector shown in FIG. 1.

FIG. 5 is a photograph for comparing the wire connector shown in FIG. 1 with the prior art.

FIGS. 6 to 11 are photographs showing a process of connecting two wires using the wire connector shown in FIG. according to an embodiment of the present invention.

### BEST MODE

Hereinafter, preferred embodiments of the present invention will be described in detail with reference to the accompanying drawings.

Prior to the description of the present invention, terms and words used in the present specification are not to be interpreted as being unconditionally limited to their usual and dictionary meanings. More particularly, it should be understood that, in order for the present inventors to explain the invention in the best way, the concepts of diverse terms may be appropriately defined and used and, furthermore, these terms or words are duly construed as meanings and concepts consistent with the technical idea of the present invention.

In other words, the terms used in this specification are only used to describe a preferred embodiment of the present invention, and are not intended to specifically limit the content of the present invention, and it should be note that these terms are defined in consideration of various possibilities f the present invention. [symbol] e

Further, in the present specification, it should be understood that the singular expression may include a plural expression unless clearly indicated in different meanings in the context and, even if similarly expressed in the plural, the singular expression may be included therein.

Throughout the present specification, when a component is described as “including” another component, it could mean that the above component does not exclude any other component but further include any other component unless otherwise indicated.

Further, in the case where a component is described as “existing inside or connected or installed in” another component, it could mean that: the component may be directly connected or installed in contact with the other component; or the component may be installed spaced apart from the other component by a predetermined distance. And, in the case where a component is installed spaced apart from the other component by a predetermined distance, a third component or means for fixing or connecting the component to the other component may exist and, in this case, it should be noted that a description of the third component or means may be omitted.

On the other hand, when a component is described as being “directly connected” or “directly linked” to another component, it should be understood that there is no third component or means therebetween.

Likewise, other expressions describing the relationship between respective components such as “between” and “directly between”, or “neighbor to (or adjacent to)” and “directly neighbor to (adjacent to)”, etc. should be interpreted as having the same purposes.

Further, in the present specification, terms such as “one surface”, “the other surface”, “one side”, “the other side”, “first”, “second”, etc. are used to clearly distinguish one component from other components, and it should be noted that the meanings of the components are not limitedly used by such terms.

Further, in the present specification, terms related to positions (locations) such as “upper”, “lower”, “left”, “right”, etc., if used herein, should be understood as indicating a relative position in the drawings with respect to the corresponding component. Further, the position-related terms should not be understood as referring to absolute positions unless the absolute positions are specified by the terms.

In addition, in the specification of the present invention, terms such as “ . . . part”, “ . . . unit”, “module”, “device”, etc., if used herein, may refer to a unit capable of processing one or more functions or operations, and it should be noted that the above unit may be implemented in hardware, software or a combination of hardware and software.

Further, in the present specification, with regard to the reference numeral specified for each of components in each drawing, even if the components are also indicated in different drawings, the same reference numerals are given for the same components, that is, the same reference numerals are used to the same components throughout the specification.

In the drawings attached to the present specification, the size, position and coupling relationship of each constitutional component in the present invention may be partially exaggerated or reduced, or a detailed description thereof may be omitted in order to sufficiently, obviously or clearly explain the spirit of the present invention or for convenience of description. Therefore, a proportion or scale thereof may not be exactly defined.

In addition, in the following description of the present invention, a detailed description of some configurations determined to unnecessarily obscure the subject matter of the present invention, for example, a known technology including the prior art, may be omitted.

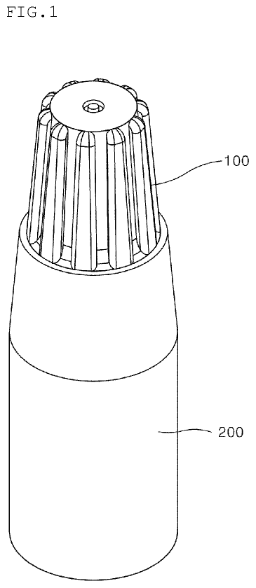

FIG. 1 is an external perspective view of a wire connector according to an embodiment of the present invention, wherein a wire connection unit 100 and a bond type heat-shrinkable tube 200 are included.

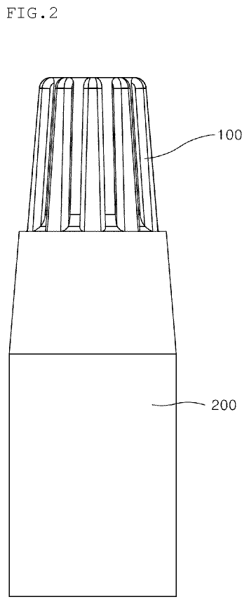

FIG. 2 is a front view of the wire connector shown in FIG. 1, wherein the wire connection unit 100 and the bond type heat-shrinkable tube 200 are included.

FIG. 3 is an enlarged cross-sectional view of the wire connection unit 100 in the wire connector shown in FIG. 2, wherein a housing 110 and a metal insert 120 are included.

Referring to FIGS. 1 to 3, the configuration and function of each component in the wire connector according to an embodiment of the present invention will be schematically described as follows.

The wire connection unit (twisted on the wire connector, 100) may be in a cap type having an outer peripheral surface in a serrated form, and may connect stripped portions 55 of a plurality of wires to be connected, which was inserted therein, in a twisted form through rotation of the wire connection unit 100.

That is, the housing 110 in the wire connection unit 100 may have a tapered cylindrical shape, in which a radius of an open lower part is larger than that of a closed upper side, wherein a plurality of wires stripped off may be inserted into the lower part, while the metal insert 120 is placed inside the housing 110 and is formed in a hollow and tapered cylindrical shape having a screw-shaped outer surface.

The bond type heat-shrinkable tube (or an adhesive-lined heat shrinkable tube, 200) is in a hollow cylindrical form, and has one side integrally attached to a lower outer peripheral surface of the wire connection unit 100, and the other side, through which the plurality of wires to be connected is inserted, thereby being shrunk when heated.

FIG. 4 is a partially cut-away view of the wire connector shown in FIG. 1, wherein a hosing 110, a metal inset 120, and a non-stripped portion 50 and a stripped portion 55 of the wire to be connected are included.

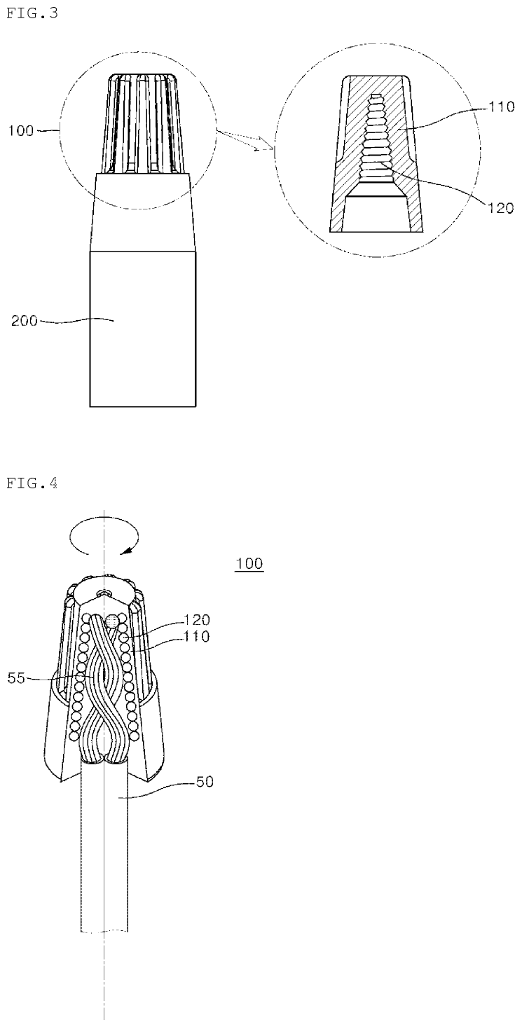

FIG. 5 is a photograph for comparing the wire connector shown in FIG. 1 with the prior art: (a) in a state in which wire connection is completed according to an embodiment of the present invention; (b) in a state in which wire connection is completed using a conventional insulation tape; and in a state in which wire connection is completed by only the conventional wire connector.

In FIG. 5, in the case of (a), the non-stripped portion 50 of the wire to be connected, the wire connection unit 100 and the bond type heat-shrinkable tube 200 are included. In the case of (b), the wire connector 10, the insulation tape 20 and the non-stripped portion 50 of the wire to be connected are included. Further, in the case of (c), the wire connector 10 and the non-stripped portion 50 of the wire to be connected are included.

FIGS. 6 to 10 are photographs illustrating a process of connecting two wires by the wire connector shown in FIG. according to an embodiment of the present invention, wherein a portable turbo-lighter 30, the non-stripped portion 50 and the stripped portion 50 of the wire to be connected, the wire connection unit 100 and the bond type heat-shrinkable tube 200 are included.

Referring to FIGS. 1 to 11, a process of connecting wires using the wire connector according to an embodiment of the present invention will be described in detail below.

The wire connector of the present invention may include a wire connection unit 100 and a bond type heat-shrinkable tube 200, wherein the wire connection unit 100 is provided with a housing 110 and a metal insert 120.

The housing 110 may be formed of an insulating material such as plastic or ceramic, etc., and may have a tapered cylindrical shape wherein an open lower part thereof has a larger radius than a radius of a closed upper side thereof, and wherein a plurality of stripped wires is inserted into the lower part.

Further, a plurality of serrated grooves may be formed on the outer peripheral surface of the housing 110 in order to facilitate rotation by a user with a finger.

Meanwhile, the housing 110 may be provided with a tapered cylindrical metal insert 120 therein, which is formed of an electrically conductive material such as a metal substance, for example, steel or copper and has a screw-shaped outer surface.

In other words, the metal insert 120 may be formed in a tapered coil type, and the stripped portion 55 of the wire to be connected is firstly inserted inside the metal insert, and then is pulled inward and twisted by the metal insert 120, as shown in FIG. 4, when a user rotates the housing 110 in a predetermined direction, thereby being completely connected.

At this time, since the housing 110 is made of an insulating material in a form to surround the metal insert 120 made of a metal material, occurrence of electric shock accidents or short circuit may be prevented by the metal insert 120 made of a metal material in which a current flowing wire is fixed.

Further, after peeling off a part of the cover (the sheath) of a plurality of wires to be connected and before inserting the same into the wire connection unit 100, there is no need for pre-twisting the stripped portion 55 or for simply connecting the same through soldering, instead, the stripped portion 55 of the wires to be connected may be firmly connected by rotating the wire connection unit 55 in a predetermined direction while the stripped portion 55 of the wires is inserted into the wire connection unit 100.

Meanwhile, the bond type heat-shrinkable tube 200 may be formed in a cylindrical shape with both open sides such that one side thereof is integrally attached to a lower outer peripheral surface of the wire connection unit 100, and the wire to be connected is inserted through the other side and can penetrate to the above one side.

Further, the bond type heat-shrinkable tube 200 may have a minimum shrinkage temperature of 120° C., a shrinkage rate of 3:1 to 6:1, that is, 33.3 to 16.7%, and a product name printed on the outer peripheral surface thereof.

The bond type heat-shrinkable tube 20 may be composed of an outer surface and an inner surface, wherein the outer surface is made of any one of polyolefin (PO), polyvinylidene fluoride (PVDF) and soft polyvinyl chloride, which are cross-linked by radiation.

Further, the inner surface of the bond type heat-shrinkable tube 200 may be made of an adhesive material, in particular, may be formed of any one of an ethylene-vinyl acetate copolymer (EVA)-based adhesive and a polyamide (PA)-based adhesive.

The bond type heat-shrinkable tube 200 is heated using a predetermined heat source for a predetermined period of time to be heat-shrunk, thereby sealing the non-stripped portion 50 of the wire to the lower part of the wire connection unit 100 without a gap so as to ensure waterproofing while preventing corrosion of the stripped portion 55 of the wire to be connected.

On the other hand, as shown in FIG. 5(b), if wire connection is completed using the conventional insulation tape 20, the insulation tape 20 may be aged due to lone use and partially peeled off. For this reason, moisture may penetrate between the wire connector 10 and the wire to be connected, hence causing corrosion of a stripped portion of the wire connected inside the wire connector 10.

Further, as shown in FIG. 5(c), if wire connection is completed only using the conventional wire connector 10, foreign substances such as moisture and dust may inflow into the opening of the wire connector 10 and cause electrical problems such as electrical short circuits, poor contact and electrical leakage. Further, when a connected part of the wire inside the wire connector 10 is aged, a phenomenon that the connected part of the wire is easily falling out due to vibration, shaking, movement, etc. may occur.

Referring to FIGS. 1 to 11, an operation of wire connection using the wire connector according to an embodiment of the present invention will be described in detail below.

First, as shown in FIG. 6, the sheath of each of the wires to be connected is peeled off by a predetermined length.

Herein, the predetermined length is preferably in a range of about 70 to 80% of a vertical length of the wire connection unit 100.

When the length is less than the above range, the wire to be connected may come off from the wire connector due to external vibration or shaking. Further, the length is more than the range, a plurality of stripped wires may be exposed to the outside of the wire connection unit 100.

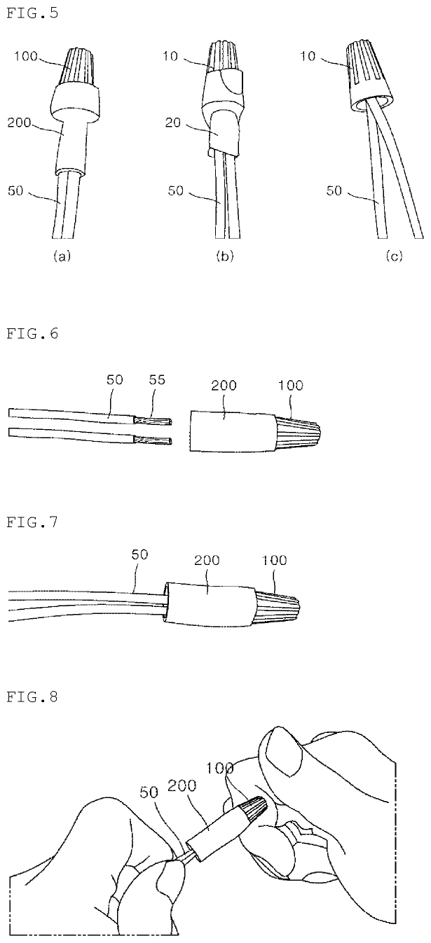

As shown in FIG. 7, the plurality of stripped wires may be inserted into the wire connection unit 100. In the present embodiment, two wires among the plurality of wires only are illustrated for convenience of understanding.

As shown in FIG. 8, non-stripped portions 50 of the two wires are held with one hand while holding the wire connection unit 100 with the other hand, and then, the wire connection unit 100 is rotated clockwise to twist the wires until the wire connection unit does not rotate any more.

At this time, the stripped portions 55 of the wires to be connected, which were inserted into the metal insert 120 of the wire connection unit 100, are twisted in the form of a twisted bread stick inside the metal insert 120 as shown in FIG. 4, thereby being firmly connected.

In order to check whether the wire to be connected is firmly connected in the wire connection unit 100, the wire may be pulled out to test wire disconnection.

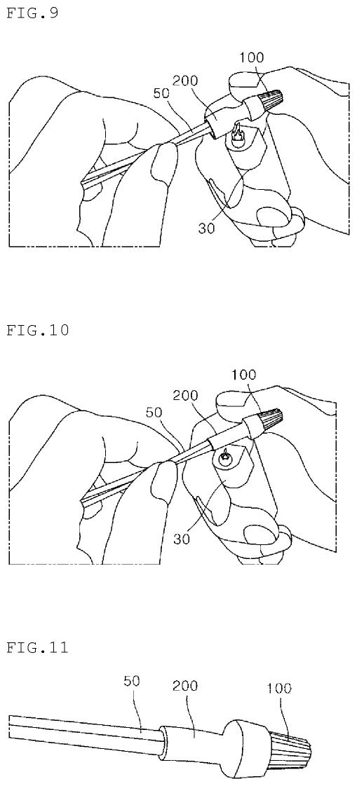

As shown in FIG. 9, the bond type heat-shrinkable tube part 200 may be subjected to heating using a heat source for a predetermined time.

In this case, the heat source used herein may be a hot air fan, a portable torch or a portable turbo-lighter having a heating temperature of at least 120° C.

This is because the heat-shrinkable tube may have excellent flame-retardant properties to thus be less damaged by the heat source, thereby having a high degree of completion after heating.

However, since the wire connection unit 100 is made of a synthetic resin such as plastic and does not have as high flame retardant properties as the heat-shrinkable tube, it should be noted that the heat-shrinkable tube part only excluding the wire connection unit part 100 must be heated as shown in FIG. 10.

According to an embodiment of the present invention, the stripped portions 55 of the two wires to be connected are firmly connected within the wire connection unit 100, and the non-stripped portion 50 of the wire is sealed to the lower part of the wire connection unit 100 by the bond type heat-shrinkable tube as shown in FIG. 11, thereby enabling high safety wire connection.

The wire connector of the present invention manufactured by such a process as described above may be widely used for electrical wiring work in diverse types of construction sites such as residential, commercial or industrial applications, etc., as well as wire connection of fixtures such as home appliances, lightening and/or kitchen equipment.

As described above, with regard to the wire connector for peeling off a portion of a plurality of wire sheaths and then connecting the same, the present invention may provide a wire connector that can reliably finish wire connection of a stripped portion of the wire inserted inside the wire connector through rotation of the wire connection unit having an outer peripheral surface formed in a serrated shape, while sealing a non-stripped portion of the wire to a lower part of the wire connection unit without any gap by the bond type heat-shrinkable tube having a high shrinkage rate

Through this, it is possible to prevent a hassle caused by the conventional wire covering method using an insulation tape, as well as electrical problems caused by corrosion of the wire due to ageing of the insulation tape and inflow of foreign substances.

Further, even if the connected part of the wire is aged or a lower diameter of the wire connection unit is larger than a diameter of the inserted wires, it is possible to prevent the connected part of the wire from falling out due to vibration or shaking caused by weather, movement, etc. since the bond type heat-shrinkable tube has a high shrinkage rate.

As such, several embodiments of the present invention have been described by way of some examples, however, the description of various embodiments included in the “detailed description of preferred embodiments for carrying out the invention” is merely exemplary, and those skilled in the art to which the present invention pertains will be well understood from the above description that the present invention can be variously modified and implemented and/or equivalents of the present invention may be possible.

In addition, since the present invention can be implemented in a variety of other forms, the present invention is duly not limited by the above description, instead, the above description is intended to complete the disclosure of the present invention and is generally provided only to completely inform the scope of the present invention to those skilled in the art to which the present invention pertains. Therefore, it should be noted that the present invention is only defined by each claim of the appended claims.

1. A wire connector, comprising:
a wire connection unit configured in a cap shape having an outer peripheral surface in a serrated shape to connect stripped portions of a plurality of wires to be connected, which were inserted into the wire connector, in a twisted form through rotation thereof by a built-in metal insert of the wire connection unit; and
a bond type heat-shrinkable tube configured in a hollow and cylindrical shape that has one side integrally attached to a lower outer peripheral surface of the wire connection unit and an other side in the opposite direction, through which the plurality of wires to be connected is inserted, thereby being shrunk when heated.

2. The wire connector according to claim 1, wherein the wire connection unit includes:
a housing in a tapered cylindrical shape, in which a radius of an open lower part is larger than a radius of a closed upper side, wherein the plurality of wires to be connected is inserted into the lower part; and
a metal insert that is disposed inside the housing and is formed in a hollow and tapered cylindrical shape having a screw-shaped outer surface, into which the stripped portion is inserted and connected.

3. The wire connector according to claim 2, wherein the housing is formed of an insulating material such as a plastic or ceramic material.

4. The wire connector according to claim 2, wherein the housing is rotated in a predetermined direction while the stripped portion is inserted into the wire connection unit, so as to connect the stripped portion in a twisted shape.

5. The wire connector according to claim 4, wherein the metal insert is formed in a taper coil shape to twist the stripped portion and then connect the same therein through rotation of the wire connection unit.

6. The wire connector according to claim 2, wherein the metal insert is made of an electrically conductive material including steel and copper.

7. The wire connector according to claim 5, wherein the bond type heat-shrinkable tube shrinks a part of a non-stripped portion of the wire to be connected, which was connected to the lower part of the wire connection unit, by heating the part using a predetermined heat source, while sealing the non-stripped portion to the lower part of the wire connection unit.

8. The wire connector according to claim 7, wherein the predetermined heat source is any one of a torch, a hot air fan and a portable turbo-lighter.

9. The wire connector according to claim 1, wherein the bond type heat-shrinkable tube has a shrinkage rate of 3:1 to 6:1.

10. The wire connector according to claim 1, wherein the outer surface of the bond type heat-shrinkable tube is made of any one of polyolefin (PO), polyvinylidene fluoride (PVDF) and soft polyvinyl chloride (PVC), which is being cross-linkable by radiation.

11. The wire connector according to claim 1, wherein the inner surface of the bond type heat-shrinkable tube is made of any one of an ethylene-vinyl acetate copolymer (EVA)-based adhesive and a polyamide (PA)-based adhesive.
